(19) United States
(12) Patent Application Publication
(10) Pub. No.: US 2003/0063280 A1
(43) Pub. Date: Apr. 3, 2003

(54) Monochromator

(76) Inventors: Hiroshi Ando, Tokyo (JP); Eiji Ishikawa, Tokyo (JP)

Correspondence Address: FLYNN THIEL BOUTELL & TANIS, P.C., 2026 RAMBLING ROAD, KALAMAZOO, MI, 49008-1699, US

(21) Appl. No.: 10/231,329

(22) Filed: Aug. 29, 2002

(30) Foreign Application Priority Data
Sep. 28, 2001 (JP) 2001-298940

(51) Int. Cl. G01J 3/51

(52) U.S. Cl. 356/419

(57) ABSTRACT

There is provided a monochromator capable of downsizing thereof. According to a monochromator, a light transmission hole through which beam of light which is given out from a light source is transmitted and multiple plate-like filter blocks each having central axis of rotation which is parallel with beam of light are provided on a filter base. Various optical filters are attached to the holes of filter blocks and the filter block serves as a light shielding block. The filter blocks attached to the rotary shafts of motors are reciprocally rotated between a forward position of the optical transmission hole serving as a position of transmission of light and a standby position spaced away from the optical transmission hole so that the filter blocks can be downsized, and even if there are many patterns of combination of optical filters, multiple optical filters can be easily combined with each other and even if the optical filters are used singly or used while combined with each other, which does not take time for changing the optical filter, thereby enhancing efficiency compared with the conventional monochromator.

### FIELD OF THE INVENTION

The invention relates to a monochromator capable of obtaining desired light by transmitting light, which is given out from a light source, through a selected optical filter.

### BACKGROUND OF THE INVENTION

A monochromator disperses light comprised of multiple colors and multiple wavelengths into light comprised of a single color and a single wavelengths, and a monochromator employing an optical system allows incident light to transmit through an optical filter and the like, thereby allowing only light having a specific wavelength range to pass therethrough or to attenuate or block off power of light.

There is a monochromator 100 serving as a conventional monochromator as shown in FIGS. 7 to 9. The monochromator 10 has a motor fixation plate 101 for fixing a motor to a structure and the like, and a base plate 102 provided vertically on the motor fixation plate 101 in FIG. 7. A light path 103, through which beam of light BM is transmitted, is provided on the upper portion of the base plate 102 (upper portion in FIG. 8).

A stepping motor 104 is fixed to the base plate 102 at the position close to the center thereof in a manner that a rotary shaft 105 becomes in parallel with the light path 103. A discoid filter block 106 is fixed to one end portion of the rotary shaft 105 (right side end in FIG. 8) perpendicularly to the rotary shaft 105. An optical filter 107, which comprises a first optical filter 107a, a second optical filter 107b, an optical filter 107c formed of the combination of the first and second optical filters 107a, 107b and the like, is provided along the periclinal portion of the filter block 106.

A detecting plate 108 is fixed to the other end portion of the rotary shaft 105 of the stepping motor 104 (left side end in FIG. 8) so as to detect the origin of the filter block 106. A hole, not shown, is provided on the detecting plate 108 at the position of the origin of the filter block 106, and a position detection sensor 109 for detecting the hole of the detecting plate 108 is provided at the position close to the detecting plate 108. Accordingly, the filter block 106 is rotated while controlling a rotation angle of the stepping motor 104 on the basis of the origin which was detected by the position detection sensor 109 so as to position a desired optical filter 107 relative to the light path 103, so that the beam of light BM is transmitted through the selected optical filter 107.

According to the monochromator 100 as set forth above, the number of optical filter 107 is increased by the number of patterns of the combination of the optical filters 107, if the combination of the optical filter 107 is required, and hence the number of the optical filter 107 is increased, thereby enlarging the size of the filter block 106. Accompanied by this, the size of the filter block 106 is also enlarged, causing a problem that the monochromator 100 is enlarged as a whole.

### SUMMARY OF THE INVENTION

The invention has been developed in view of the problem of the foregoing monochromator, and it is an object of the invention to provide a monochromator which can be downsized.

To achieve the above object, according to a first aspect of the invention, a monochromator capable of obtaining desired light by transmitting the beam of light, which is given out from a light source, through an optical filter selected from multiple optical filters, and it is characterized in comprising a filter block including a central axis of rotation in a direction orthogonal to the beam beam of light which is given out from the light source, and formed of a plurality of filter holders capable of holding the optical filters so as to transmit the light radially from the central axis of rotation, and a rotary mechanism for rotating the filter block so as to index a desired optical filter at a position orthogonal to a position of transmission of beam of light which is given out from the light source.

With the monochromator having the forgoing construction, the filter block having the central axis of rotation in a direction orthogonal to the beam of beam of light which is given out from the light source, has the optical filters which are disposed radially from the central axis of rotation so that the rotary mechanism can position a desired optical filter at a position of transmission of light by rotating the filter block around the central axis of rotation. As a result, the filter block can be downsized according to the monochromator of the invention, thereby solving the problem of an enlargement of the conventional monochromator is enlarged.

The monochromator according to a second aspect of the invention is characterized in further comprising, according to the first aspect of the invention, a detecting plate for detecting a position of rotation of the filter block, and a positioning sensor for detecting the detecting plate respectively fixed to one of the filter holders.

According to the monochromator having the foregoing construction, the detecting plate is fixed to one of the multiple filter holders of the filter block, and the detecting plate is detected by the positioning sensor so that a reference position of the filter position can be detected.

Further, the monochromator according to a third aspect of the invention is characterized in further comprising, according to the first aspect of the invention, a light shielding plate fixed to at least one of the filter holders so that a corresponding filter holder is appropriately selected to be indexed at a position orthogonal to a position where the beam of beam of light which is given out from the light source, by appropriately selecting the corresponding filter holder, thereby shielding light.

Further, according to a fourth aspect of the invention, a monochromator is capable of obtaining desired light by transmitting the beam of light, which is given out from a light source, through an optical filter selected from multiple optical filters, and it is characterized in comprising multiple filter blocks capable of reciprocally rotating between a position of transmission of light through which the light transmits the optical filter and a standby position about a central axis of rotation which is parallel with the beam of light which is given out from the light source, and capable of holding each optical filter so as to transmit light, and a rotary mechanism for rotating the filter blocks so as to position the filter blocks at the standby position or the position of transmission of light.

With the monochromator having the foregoing construction, each filter block is provided for every optical filter, and each filter block is rotated by the rotary mechanism to be positioned at the position of transmission of light or standby position so that each filter block can be downsized. Further, even in a case where there are many patterns of combination of optical filters, the monochromator can cope with such a case without increasing the number of filter blocks, thereby solving the problem of the enlargement of the conventional monochromator.

The monochromator according to a fifth aspect of the invention is characterized in that, according to the fourth aspect of the invention, the rotary mechanism controls each filter block independently to turn on or off so as to position each filter block at the position of transmission of light or standby position.

With the monochromator having the foregoing construction, since each filter block for holding each optical filter is independently controlled to be turned on or off so as to be positioned at the position of transmission of light or standby position, so that it can cope with many patterns of combination of the optical filters. Accordingly, the monochromator having the foregoing construction can avoid the enlargement of each filter block even if the number of combination of each optical filter is increased, thereby solving the problem of the enlargement of the conventional monochromator.

The monochromator according to a sixth aspect of the invention is characterized in further comprising, according to the fourth aspect of the invention, a light shielding plate fixed to at least one of the filter blocks, so that light can be shielded by appropriately selecting a corresponding filter holder and positioning the selected filter at a position orthogonal to the position of transmission of beam of light which is given out from the light source.

The monochromator according to a seventh aspect of the invention is characterized in that, according to the fourth aspect of the invention, each filter block can position each corresponding optical filter at the position of transmission of light so as to laminate it along the direction of transmission of light, so that when each filter block is selectively positioned at the position of transmission of light, various kinds of light number of which is greater than the number of optical filter can be obtained even if each kind of optical filter is formed of one piece.

### BRIEF DESCRIPTION OF THE DRAWINGS

FIG. 1 is a perspective view showing a first embodiment of a monochromator according to the invention.

FIG. 2 is an exploded view of the monochromator as shown in FIG. 1.

FIG. 3 is a perspective view showing a second embodiment of a monochromator according to the invention.

FIG. 4 is a front view as viewed from an arrow IV in FIG. 3.

FIG. 5 is a side view as viewed from an arrow V in FIG. 4.

FIG. 6 is a plan view as viewed from an arrow VI in FIG. 4.

FIG. 7 is a front view showing a conventional monochromator.

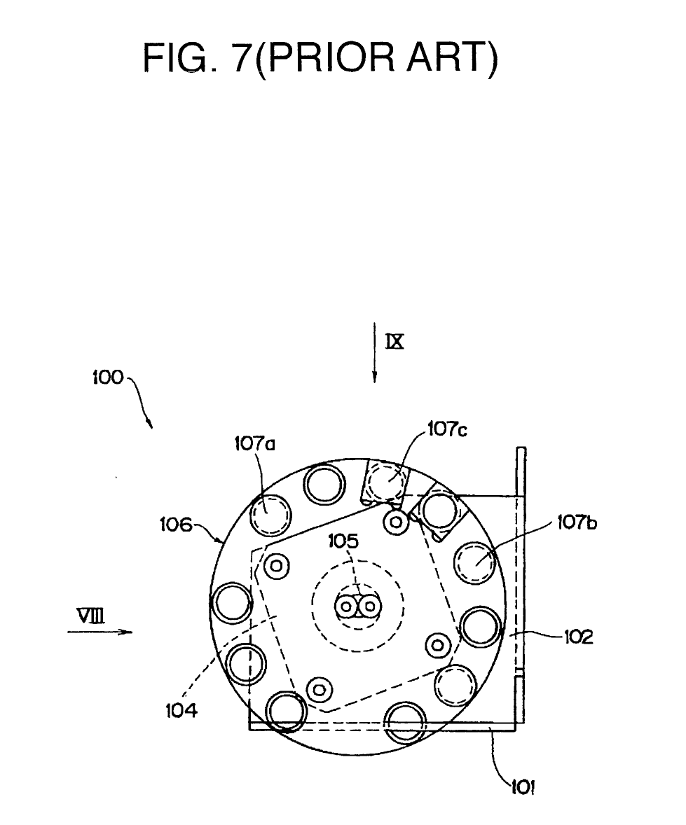

FIG. 8 is a side view as viewed from an arrow VIII in FIG. 7.

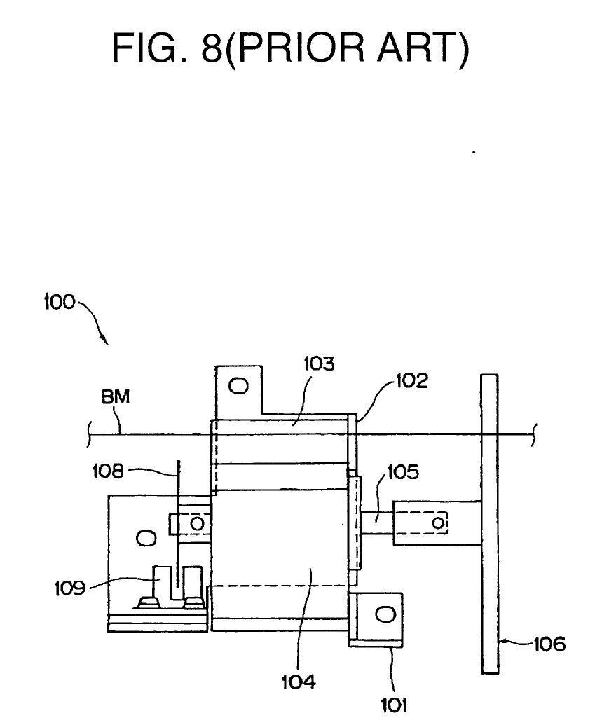

FIG. 9 is a plan view as viewed from an arrow IX in FIG. 7.

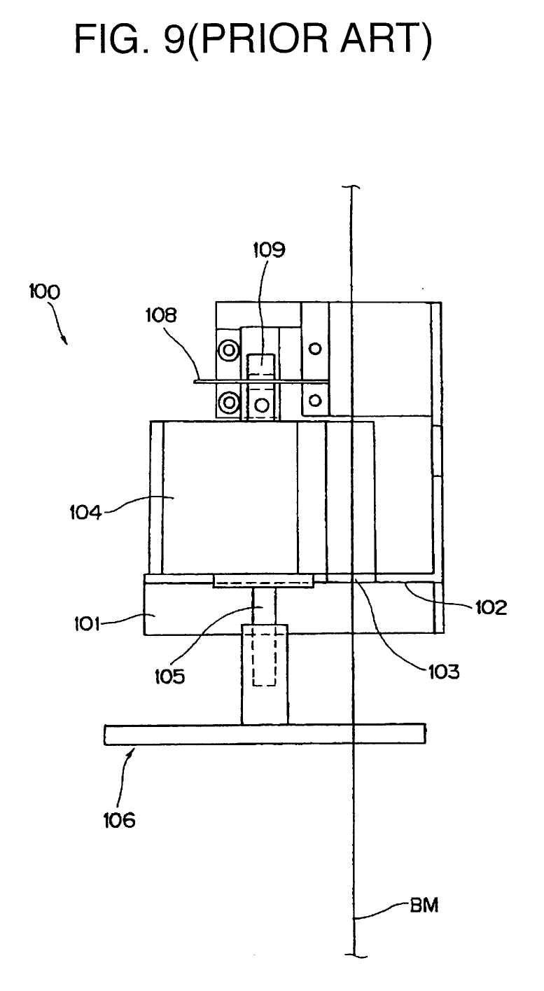

### PREFERRED EMBODIMENT OF THE INVENTION

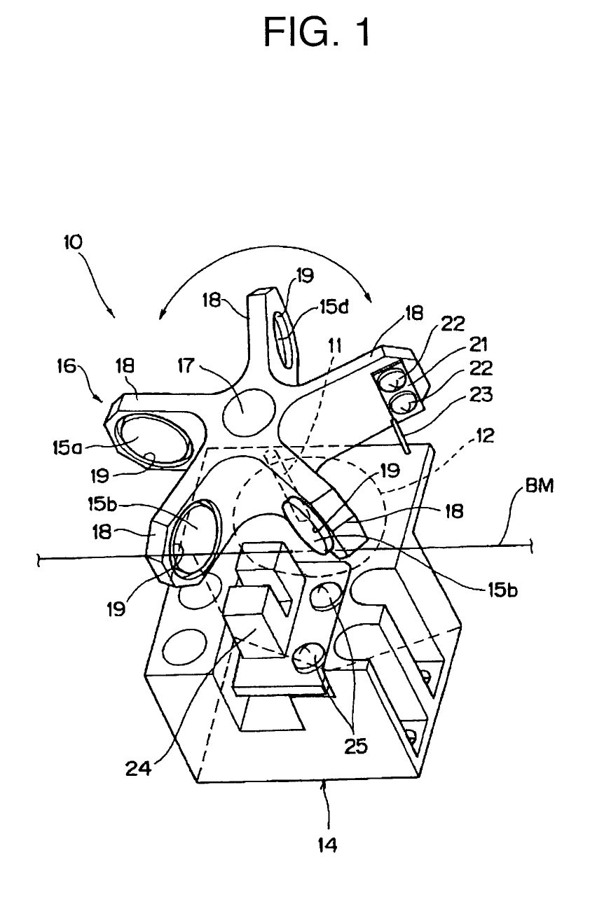

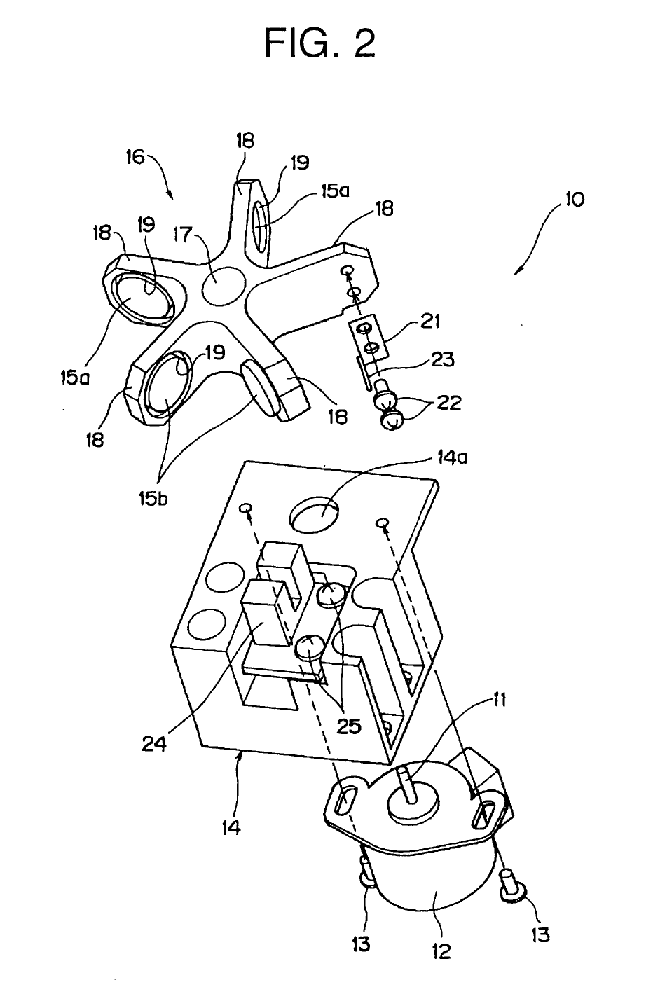

An monochromator according to a first embodiment of the invention is now described with reference to FIGS. 1 and 2. FIG. 1 is a perspective view of the monochromator according to the invention, and FIG. 2 is an exploded view of the monochromator as shown in FIG. 1.

As shown in FIG. 1, a monochromator 10 includes a motor 12 serving as a rotary mechanism and having a rotary shaft 11 in the direction orthogonal to beam of light (BM) which is given out from a light source, not shown, and a base 14 to which the motor 12 is fixed by bolts 13. The rotary shaft 11 of the motor 12 protrudes upward from a hole 14a of the base 14, and it is fixed to a central axis of rotation 17 of a filter block 16 to which multiple optical filters 15a, 15b are attached. Accordingly, the filter block 16 is rotated around the central axis of rotation 17 which is positioned orthogonal to the beam of light BM given out from the light source.

The filter block 16 has multiple plate-like filter holders 18 (5 pieces in FIG. 1) which are extended radially from the central axis of rotation 17. The filter holders 18 have holes 19 through which the beam of light BM is transmitted and the multiple optical filters 15a, 15b are formed on the holes 19 so as to cover the holes 19. A detecting plate 21 for detecting a rotary position (e.g. position of the origin) of the filter block 16 is fixed to one of the filter holders 18 by bolts 22, and a detection element 23 is protruded downward (downward in FIG. 1) from the filter block 16. A positioning sensor 24 for detecting the detection element 23 is fixed to the base 14 by bolts 25.

Accordingly, when light is dispersed using a desired optical filter 15, the motor 12 is rotated by an angle ranging from the filter holder 18 to which the detecting plate 21 is fixed to the filter holder 18 to which a desired optical filter 15 is fixed based on a position where the positioning sensor 24 detected the detection element 23, thereby indexing the desired optical filter 15 at a position which is orthogonal to the position where the beam of light BM is transmitted.

According to the monochromator 10 of the invention, since the filter block 16 for holding the multiple optical filters 15 is rotated about the central axis of rotation 17 which is orthogonal to the beam of light BM given out from the light source, the filter block 16 can be downsized, so that the monochromator 10 can be downsized as a whole.

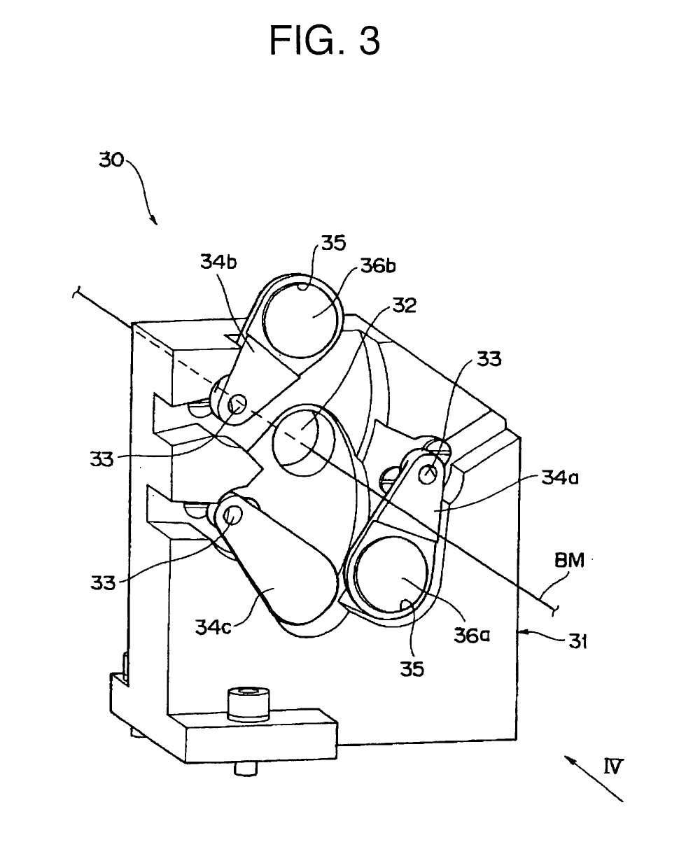

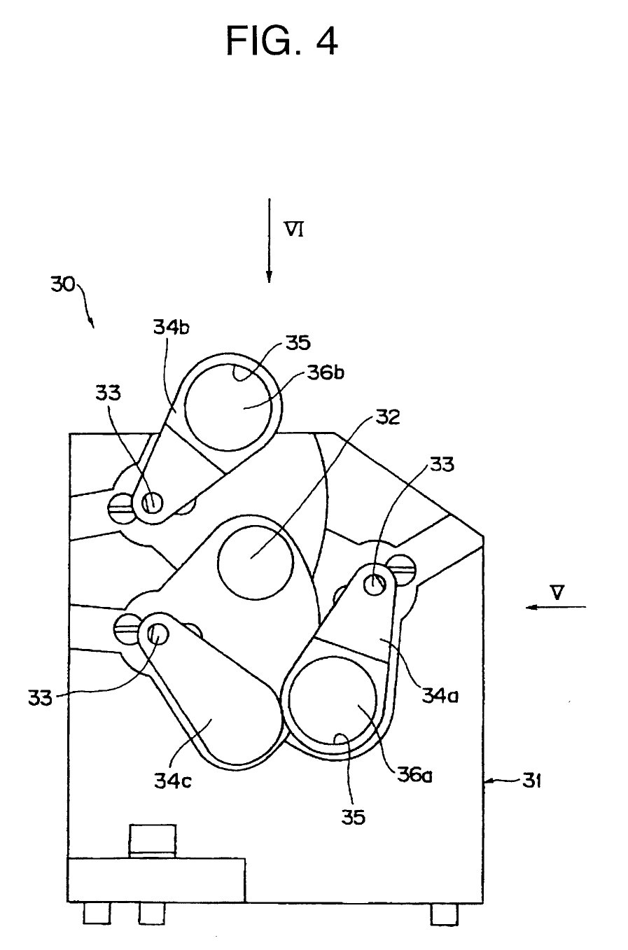

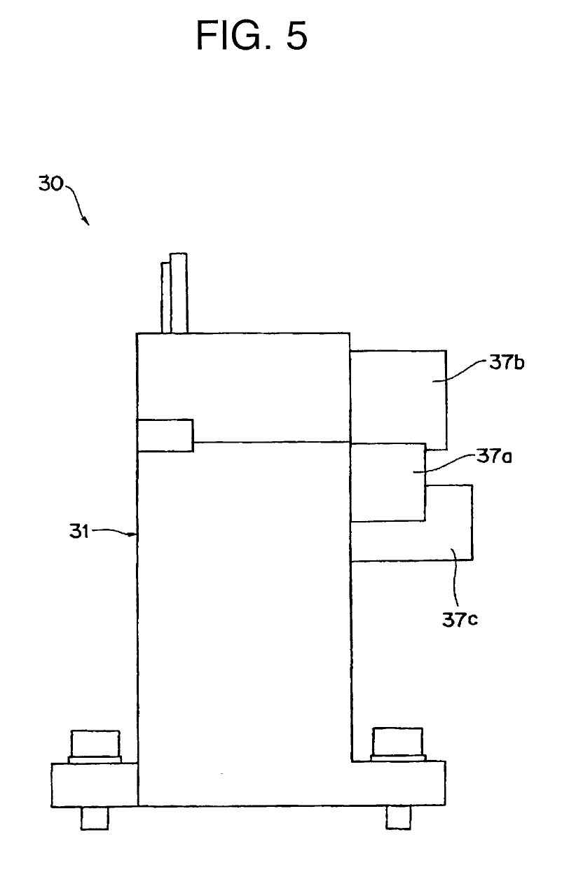

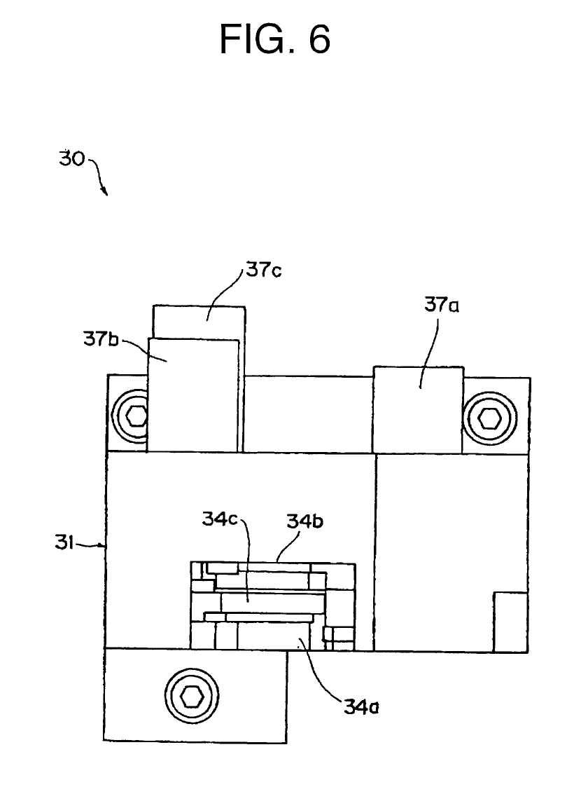

A second embodiment of the invention is now described with reference to FIGS. 3 to 6. FIG. 3 is a perspective view of a monochromator according to the invention, FIG. 4 is a front view, FIG. 5 is a side view, and FIG. 6 is a plan view.

As shown in FIG. 3, according to a monochromator 30, a light transmission hole 32 through which beam of light BM which is given out from a light source, not shown, is transmitted is provided on a filter base 31. Multiple plate-like filter blocks 34a, 34b, 34c each having central axis of rotation 33 which is parallel with the beam of light BM and capable of reciprocally rotating about the central axis of rotation 33 are provided on the filter base 31. The filter block 34c serves as a light shielding block.

A hole 35 is provided in each of the filter blocks 34a, 34b and various optical filters 36a, 36b are attached to the holes 35. The central axes of rotation 33 of the respective filter blocks 34a, 34b, 34c are attached to the rotary shafts of motors 37a, 37b, 37c serving as a rotary mechanism, not shown, wherein when the motors 37a, 37b, 37c are rotated, the respective optical filters 36a, 36b are reciprocally rotated between a forward position of the optical transmission hole 32 serving as a position of transmission of light and a standby position spaced away from the optical transmission hole 32. When the motors 37a, 37b, 37c are turned on, the filter blocks 34a, 34b, 34c are rotated so as to position the optical filters 36a, 36b at the position of transmission of light, while when the motors 37a, 37b, 37c are turned off, the optical filters 36a, 36b are moved to the standby position.

Accordingly, when light is dispersed using a desired optical filter 36a, only the motor 37a of the filter block 34 for holding the optical filter 36a is turned on, and the other motors 37b, 37c are turned off. For example, if the beam of light BM is transmitted as it is, all the motors 37a, 37b, 37c are turned off so as to position the filter blocks 34a, 34b, 34c at the standby position.

Likewise, when the beam of light BM is intended to pass through the optical filter 36b, only the motor 37b is turned on to position the filter block 34b at the position of transmission of light, while the other motors 37a, 37c are turned off so as to position the filter blocks 34a, 34c at the standby position. Further, when the beam of light BM is intended to pass through the optical filters 36a, 36b, only the motors 37a, 37b are turned on while the motor 37c alone is turned off so as to arrange the optical filters 36a, 36b to be laminated along the direction of transmission light. Still further, when light is intended to be shielded, the motors 37c is turned on to position the filter blocks 34c at the position of transmission of light.

According to the monochromator 30, the filter blocks 34a, 34b, 34c for holding the multiple optical filters 36a, 36b are independently controlled to be turned on or off so that the filter blocks 34a, 34b, 34c can be downsized, and even if there are many patterns of combination of optical filters, multiple optical filters 36a, 36b can be easily combined with each other.

In the conventional monochromator, since the optical filters are arranged along the peripheral direction of the filter blocks, for example, when an optical filter to be used next is arranged at the position opposite to the radial direction of the filter block after another optical filter is used, the filter block has to be turned 180 degrees, which takes time for changing the optical filter, rendering monochromator inefficient. On the other hand, according to the monochromator 30 of the invention, since the filter blocks 34a, 34b, 34c are independently controlled to be turned on or off, even if the optical filters 36a, 36b are used singly or used while combined with each other, which does not take time for changing the optical filter, thereby enhancing efficiency compared with the conventional monochromator. The monochromator of the invention is not limited to the foregoing first and second embodiments, but may be modified and improved variously.

As mentioned above, according to the invention, as described in claim 1, in the filter block having the central axis of rotation orthogonal to beam of light which is given out from the light source, the optical filters are provided radially from the central axis of rotation, the filter block can be downsized, thereby avoiding enlargement of the monochromator.

Further, according to the monochromator as set forth in claim 2, since the detecting plate is fixed to one of multiple filter holders of the filter block, and the detecting plate is detected by the positioning sensor, a reference position of the filter position can be detected, so that the optical filter can be easily selected.

Further, according to the monochromator as set forth in claim 3, since the light shielding plate is fixed to at least one of the filter holders, a corresponding filter holder is appropriately selected to be indexed at a position orthogonal to a position where the beam of light which is given out from the light source is transmitted, thereby shielding light.

Further, according to the monochromator as set forth in claim 4, since each filter block is provided for every optical filter, and each filter block is rotated by the rotary mechanism to be positioned at the position of transmission of light or standby position, each filter block can be downsized. Further, even in a case where there are many patterns of combination of optical filters, the monochromator can cope with such a case without increasing the number of filter block, and the change of optical filter can be efficiently effected.

According to the monochromator as set forth in claim 5, since each filter block for holding the optical filters is independently controlled to be turned on or off so as to be positioned at the position of transmission of light or standby position, the monochromator can cope with many patterns of combination of optical filters.

Further, according to the monochromator as set forth in claim 6, the light shielding plate is fixed to at least one of the filter blocks, light can be shielded by appropriately selecting a corresponding filter holder and indexing the selected filter at a position orthogonal to the position of transmission of beam of light which is given out from the light source.

Still further, according to the monochromator as set forth in claim 7, each filter block can position each corresponding optical filter at the position of transmission of light so as to laminate it along the direction of transmission of light, when each filter block is selectively positioned at the position of transmission of light, various kinds of light which is greater than the number of optical filter can be obtained even if the optical filter of each kind is formed of each piece.

What is claimed is:

1. An monochromator capable of obtaining desired light by transmitting beam of light, which is given out from a light source, through an optical filter selected from multiple optical filters comprising:
a filter block including a central axis of rotation in a direction orthogonal to beam of light, which is given out from the light source, and formed of a plurality of filter holders capable of holding the optical filters so as to transmit the beam of light radially from the central axis of rotation, and a rotary mechanism for rotating the filter block so as to index a desired optical filter at a position orthogonal to a position of transmission of beam of light which is given out from the light source.

2. The monochromator according to claim 1, further comprising a detecting plate for detecting a position of rotation of the filter block and a positioning sensor for detecting the detecting plate fixed to one of the filter holders.

3. The monochromator according to claim 1, further comprising a light shielding plate fixed to at least one of the filter holders.

4. An monochromator capable of obtaining desired light by transmitting the beam of light, which is given out from a light source, through an optical filter selected from multiple optical filters comprising:
multiple filter blocks capable of reciprocally rotating between a position of transmission of light through which the light transmits each optical filter and a standby position about a central axis of rotation which is parallel with the beam of light which is given out from the light source, and capable of holding the optical filter so as to transmit light, and a rotary mechanism for rotating the filter blocks so as to position the filter blocks at the standby position or the position of transmission of light.

5. The monochromator according to claim 4, wherein the rotary mechanism controls each filter block independently to turn on or off so as to position each filter block at the position of transmission of light or standby position

6. The monochromator according to claim 4, wherein a light shielding plate is fixed to at least one of the filter blocks.

7. The monochromator according to claim 4, wherein each filter block can position each corresponding optical filter at the position of transmission of light so as to laminate it along the direction of transmission of light.
